(19) United States
(12) Patent Application Publication
(10) Pub. No.: US 2021/0156016 A1
(43) Pub. Date: May 27, 2021

(54) PRODUCTION METHOD OF ALUMINUM ALLOY FORGING FOR AUTOMOBILE SUSPENSION

(71) Applicant: SHOWA DENKO K.K., Tokyo (JP)

(72) Inventor: Takumi MARUYAMA, Fukushima (JP)

(73) Assignee: SHOWA DENKO K.K., Tokyo (JP)

(21) Appl. No.: 17/104,265

(22) Filed: Nov. 25, 2020

(30) Foreign Application Priority Data
Nov. 27, 2019 (JP) 2019-213983

(51) Int. Cl. C22F 1/00; B21J 5/02; B21K 7/12; C22F 1/04

(52) U.S. Cl. CPC C22F 1/002; B21J 5/02; B21J 5/002; C22F 1/04; B21K 7/12

(57) ABSTRACT

Provided is a production method of an aluminum alloy forging for an automobile suspension having a disturbance affectable surface with not excessively notch-sensitive. The production method includes, as heat treatment processes, a solution heat treatment process, a quenching process, and an artificial age hardening process. The quenching process is performed by bringing a lower surface of the aluminum forging to be disposed on a ground side when assembled to the automobile into contact with water before an upper surface of the aluminum forging opposite to the lower surface is brought into contact with the water.

### TECHNICAL FIELD

The present invention relates to a production method of an aluminum alloy forging suitable for, e.g., a suspension for supporting a body of a four-wheel automobile.

### BACKGROUND OF THE INVENTION

An aluminum 6000 series alloy (Al—Mg—Si series alloy) for a structural member is required to be subjected to a quenching process for obtaining a supersaturated solid solution. Conventionally, a production method has been proposed in which a quenching process is performed by immersing a product in quenching water in a vertical direction or an oblique direction with respect to the water surface of the quenching water to thereby obtain high strength (see Patent Document 1).

### PRIOR ART DOCUMENT

### Patent Document

Patent Document 1: Japanese Unexamined Patent Application Publication No. 2017-179413

### SUMMARY OF THE INVENTION

### Problems to be Solved by the Invention

However, when such a structural member is assembled to an automobile and the automobile actually runs on a road surface, chipping occurs due to the disturbance by flying stones, etc., from the road surface. The disturbance may occur when small stones, etc., scattered on the road surface come into contact with the tire and an external force is applied to the small stones, etc., to scatter them. Such scattering occurs in the upward direction of the vehicle body from the road surface. The scattered stones, etc., positively come into contact with a surface of a suspension assembled to the automobile body, the surface facing the road surface, which causes a risk of causing a slight deformation (crack) of the suspension. In a situation in which a load is repeatedly applied, such deformation may result in a starting point of fractures. Therefore, there is a concern that such reliability as a suspension for supporting an automobile body may deteriorate.

Preferred embodiments of the present invention have been made in view of the above-described and/or other problems in the related art. Preferred embodiments of the present invention can significantly improve upon existing methods and/or devices.

### SUMMARY OF THE INVENTION

The present invention has been made in view of such a technical background. One of the objects of the present invention is to provide a production method of an aluminum alloy forging capable of suppressing occurrence of cracks due to chipping by enhancing the strength of a surface of the forging where chipping is likely to occur as compared with a surface where chipping is less likely to occur to thereby reduce occurrence of cracks due to chipping.

Other objects and advantages of the present invention will be apparent from the following preferred embodiments.

### Means for Solving the Problems

In order to achieve the above-described objects, the present invention provides the following means.

[1] A production method of an aluminum alloy forging for an automobile suspension, the method including, as heat treatment processes:

a solution heat treatment process;

a quenching process; and

an artificial age hardening process,

wherein the quenching process is performed by bringing a lower surface of the aluminum forging to be disposed on a ground side when assembled to an automobile into contact with water before an upper surface of the aluminum forging opposite to the lower surface is brought into contact with the water.

[2] The production method of an aluminum alloy forging for an automobile suspension as recited in the above-described Item [1],

wherein an aluminum alloy constituting the aluminum alloy forging is an Al—Mg—Si based alloy.

[3] The production method of an aluminum alloy forging for an automobile suspension as recited in the above-described Item [1], further including:

a hot forging process performed immediately before the solution heat treatment process,

wherein the solution heat treatment process is performed in conjunction with a temperature rise in the hot forging process.

[4] The production method of an aluminum alloy forging for an automobile suspension as recited in the above-described Item [2], further including:

a hot forging process performed immediately before the solution heat treatment process,

wherein the solution heat treatment process is performed in conjunction with a temperature rise in a hot forging process.

[5] The production method of an aluminum alloy forging for an automobile suspension as recited in any one of the above-described Items [1] to [4],

wherein a temperature of the water in the quenching process is 40° C. to 90° C.

### Effects of the Invention

In the invention as recited in the above-described Item [1], the quenching process is performed by bringing a lower surface of the aluminum forging to be disposed on a ground side when assembled to the automobile into contact with water before an upper surface of the aluminum forging opposite to the lower surface is brought into contact with the water. Therefore, the lower surface of the aluminum forging is more quenched as compared with the upper surface, resulting in higher strength in the lower surface than the upper surface. As a result, it is possible to provide an aluminum alloy forging for an automobile suspension capable of suppressing damage to the lower surface due to flying stones or the like as an external factor.

In the invention as recited in the above-described Item [2], it is possible to provide an Al—Mg—Si based alloy forging for an automobile suspension capable of suppressing damage to the lower surface due to flying stones of the like as an external factor.

In the invention as recited in the above-described Items [3] and [4], the solution heat treatment process is performed in conjunction with a temperature rise in a hot forging process. In other words, the solution treatment process uses a temperature rise in a hot forging process. Therefore, it is possible to provide an aluminum alloy forging for an automobile suspension capable of suppressing damage to the lower surface due to flying stones of the like as an external factor.

In the invention as recited in the above-described Item [5], the temperature of the water in the quenching process is 40° C. to 90° C. Therefore, it is possible to provide an aluminum alloy forging for an automobile suspension higher in strength.

### BRIEF DESCRIPTION OF THE DRAWINGS

FIG. 1 is a flow diagram showing the processes in the production method of the present invention.

FIG. 2 is an explanatory view schematically illustrating a quenching process in which a forging is immersed in water at an inclination angle θ with respect to the water surface when immerging the forging in the water.

FIG. 3 is an explanatory view schematically illustrating a quenching process in which a forging is immersed in water in parallel to the water surface when immerging the forging in the water.

FIG. 4 is a perspective view showing a casting used in the production method of the present invention.

FIG. 5 is a perspective view of a forging obtained by the production method of the present invention.

### EMBODIMENTS FOR CARRYING OUT THE INVENTION

A production method of an aluminum alloy forging for an automobile suspension according to the present invention will be described in detail. Note that the embodiment described below is merely illustrative, and the present invention is not limited to the embodiment and can be appropriately modified without departing from the technical concept of the present invention.

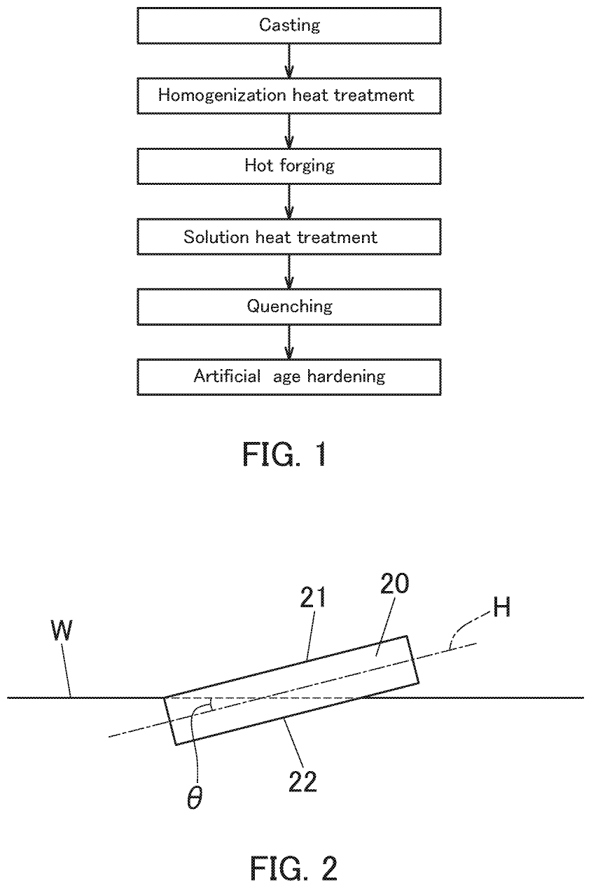

The production method of an aluminum forging for an automobile suspension according to the embodiment is to produce the aluminum alloy forging 20 for an automobile suspension as shown in FIG. 5 by performing a molten metal forming process, a casting process, a homogenization heat treatment process, a hot forging process, a solution heat treatment process, a quenching process, and an artificial age hardening process in this order (see FIG. 1). Hereinafter, each of these processes will be described.

The molten metal forming process is a process of obtaining an aluminum alloy molten metal prepared by dissolving raw materials and adjusting the composition.

In this embodiment, an Al—Mg—Si based alloy molten metal consisting of Si: 1.00 mass % to 1.20 mass %, Fe: 0.15 mass % to 0.30 mass %, Cu: 0.33 mass % to 0.45 mass %, Mn: 0.48 mass % to 0.54 mass %, Mg: 0.75 mass % to 0.95 mass %, Cr: 0.13 mass % to 0.17 mass %, and the balance being Al and inevitable impurities is obtained.

The casting process is a process of obtaining a casting (forging billet) by casting the aluminum alloy molten metal obtained in the molten metal forming process.

The casting process is not particularly limited, and a conventionally known method may be used. Examples thereof include a continuous casting and rolling method and a semi-continuous casting method (DC casting method), or the like.

The diameter of the casting is not particularly limited, but is set to, for example, 30 mm to 80 mm in diameter. In addition, the casting may be extruded with an extruder to obtain a forging billet. Also in this case, for example, it is set to 30 mm to 80 mm in diameter.

Further, in the casting process, it is preferable to set the cooling rate of the casting to 10° C./min to 50° C./min. By setting so, it is possible to produce an aluminum alloy product having a sufficiently high tensile strength at room temperature. In particular, the cooling rate of the casting is preferably set to 15° C./min to 30° C./min.

The homogenizing heat treatment process is a process in which the casting obtained in the casting process is subjected to a homogenizing heat treatment to homogenize the microsegregation caused by solidification, deposit the supersaturated solid solution elements, and convert the metastable phase to the equilibrium phase.

By performing this homogenization heat treatment, it is possible to make the intermetallic compound smaller, thereby suppressing the destruction starting from the intermetallic compound, which in turn can further improve the tensile strength.

By performing the homogenizing heat treatment, elements contained in the intermetallic compound are uniformly dispersed into the base material, which can further improve the tensile strength by the solid solution strengthening and the precipitation.

Further, the treatment temperature in the homogenizing heat treatment is preferably set in the range of 450° C. to 570° C. By performing the heat treatment at a temperature of 450° C. or higher, the intermetallic compounds, such as, e.g., crystallized substances, of the casting can be dissolved and sufficiently homogenized. By performing the heat treatment at a temperature of 570° C. or lower, burning can be prevented.

After performing such a homogenizing heat treatment process, the casting is cut to a predetermined length to obtain a forging billet.

The hot forging process is a process of heating the forging billet obtained after the homogenizing heat treatment process and applying pressure with a press to perform molding.

The temperature condition in the hot forging process is related in that the characteristics of the aluminum alloy are expressed more reproducible. That is, the microstructure of the aluminum alloy after the solution heat treatment process described later can be made into equiaxed crystal grains. In particular, the hot forging process is preferably performed by setting the mold temperature to 100° C. to 250° C. and the material temperature to 400° C. to 550° C. This is because the tensile strength of the aluminum alloy forging can be further improved by performing the hot forging under such a condition.

Next, the solution heat treatment process, the quenching process, and the artificial age hardening process will be described.

The solution heat treatment process is a heat treatment in which the aluminum alloy forging obtained in the hot forging process is held at high temperature and then rapidly cooled to form a supersaturated solid solution.

In the solution heat treatment process, it is preferable to set the heating temperature to 510° C. to 560° C. and the holding time to 0.5 hours to 6 hours. It is possible to better balance the cost and the characteristics by setting such a condition.

Further, the solution treatment process may be performed in conjunction with a process in which the temperature rise in the hot forging process is used. That is, by performing the hot forging process in conjunction with a process a solution heat treatment, the aluminum alloy forging held at a high temperature immediately after the hot forging process is subjected to the quenching process described later as it is to rapidly cool the aluminum alloy forging, thereby forming a supersaturated solid solution.

In the process performed in conjunction with the temperature rise in the hot forging process, it is preferable to set the temperature immediately after the hot forging process to 510° C. to 560° C. and the time immediately after the hot forging process to the quenching process to 1 second to 30 seconds. Under such a condition, it is possible to achieve a better balance between the costs and the characteristics in the process in conjunction with the temperature rise, as in the case of the solution treatment process.

By performing the solution heat treatment process using the temperature rise in the hot forging process as described above, as compared with the case in which the forging is slowly cooled once after the conventional hot forging process and then reheated in a continuous heating furnace or a single furnace to perform a solution heat treatment process, an aluminum alloy of the same quality can be obtained, the energy required for reheating can be saved, and the production time can also be significantly improved.

Furthermore, an aluminum alloy forging for an automobile suspension capable of suppressing damage due to flying stones, etc., as an eternal factor can be provided at a low cost.

Next, the quenching process, which is the feature of the present invention, is a heat treatment in which a solid solution state obtained in the solution heat treatment process is rapidly cooled to form a supersaturated solid solution.

In this quenching process, the quenching process is performed by bringing a lower surface of the aluminum forging to be disposed on a ground side when assembled to an automobile into contact with water before an upper surface of the aluminum forging opposite to the lower surface is brought into contact with the water.

Here, bringing the lower surface into contact with water before the upper surface means that the upper surface is brought into contact with the water after a part of the lower surface is brought into contact with the water. This includes bringing the entire area of the upper surface into contact with the water after the entire area of the lower surface is brought into contact with the water.

FIG. 2 is a diagram schematically showing a quenching process in which the forging 20 is immersed in water at an inclination angle θ with respect to the water surface W when immerging the forging 20 in the water.

Here, the angle θ is defined by the angle formed by the horizontal plane H of the forging 20 and the water surface W. Further, explaining by using the forged material 20 of the shape shown in FIG. 5 as an example, the horizontal plane H of the forging 20 denotes a plane including the centers C1 and C2 of the two assembly holes P1 and P2 of the forging 20. The center C1 is defined as the center of the assembly hole P1 in the thickness direction and the position of the center of gravity of the assembly hole P1 in the plan view. The center C2 is similarly determined.

In FIG. 5, as the forging 20, a shape having two assembly holes P1 and P2 is shown, but the number of assembly holes may be three or more.

In the quenching process of this embodiment, the forging 20 is immersed in water in a state in which the angle θ in FIG. 2 is equal to or less than 10°. With this, the lower surface 21 of the forging 20 is brought into contact with water before the upper surface 22 is brought into contact with the water to perform the quenching process.

Further, as a means for immersing the forging 20 in water in a state in which the angle of the forging 20 with respect to the water surface W is 10° or less, a robot may be used. In this case, the forging 20 is put into water with the forging being grabbed by the robot. Alternatively, a cage may be used. In this case, the cage in which the forging 20 is placed is immersed in water. Furthermore, the present invention is not limited to these means, and any means may be used as long as it is possible to dip the forging into the water so that the angle with respect to the water surface W is 10° or less.

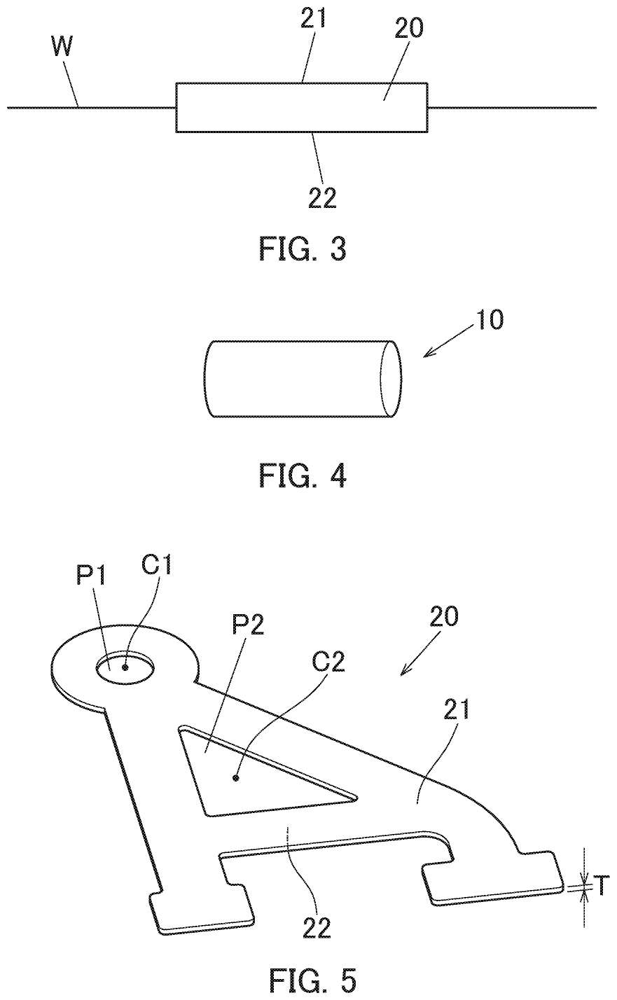

As described above, the quenching process of this embodiment is performed in a state in which the angle θ is 10° or less. However, of course, as shown in FIG. 3, the forging 20 may be horizontally put into the water with respect to the water surface W to perform the quenching process.

Note that in the quenching process of the present invention, in some cases, the forging 20 might be warped. However, in that case, it is enough to correct the warp. Therefore, as shown in FIG. 2 or 3, the lower surface 21 is brought into contact with water before the upper surface 22 is brought into contact with the water to perform the quenching process.

It is preferable that the quenching process be performed by quickly cooling (water quenching) with water at 40° C. to 90° C.

As described above, in the quenching process which is a characteristic of the present invention, by quenching with water at 40° C. to 90° C., it is possible to provide an aluminum alloy forging for an automobile suspension having higher strength.

As described above, in the quenching process, the lower surface of the aluminum forging to be disposed on a ground side when assembled to an automobile is brought into contact with water before the upper surface of the aluminum forging opposite to the lower surface is brought into contact with the water. Therefore, the lower surface of the aluminum alloy forging is more rapidly cooled as compared with the upper surface, so that the lower surface has a higher strength than the upper surface. Therefore, it is possible for the lower surface to retain the excessive supersaturated solid solution as compared with the upper surface.

The artificial age hardening process is a heat treatment for heating and holding the aluminum alloy forging at a relatively low temperature to precipitate a supersaturated solid solution element to impart the appropriate hardness.

In this embodiment, it is preferable to set the heating temperature to 160° C. to 250° C., and the retention time at 10 minutes to 8 hours. This is because the balance between the costs and the characteristics is improved by setting such condition.

In this embodiment, by performing the above-described heat treatments (solution heat treatment process, quenching process, and artificial age hardening process), it is possible to obtain an aluminum alloy forging which is uniformly dispersed in fine precipitates and highly balanced in strength, ductility, and toughness.

FIG. 5 is a perspective view showing an aluminum alloy forged product 20 for an automobile suspension obtained by the production method of the present invention. When assembled to the automobile, the forged product 20 spreads in a direction perpendicular to the thickness T direction rather than the thickness T direction, and has a shape in which there is no large protrusion in the thickness T direction. This is because it is difficult to produce the forged product in the hot forging process if there are protruding parts.

As described above, in the production method of an aluminum alloy forging for an automobile suspension, the quenching process is performed by bringing a lower surface of the aluminum forging to be disposed on a ground side when assembled to the automobile into contact with water before an upper surface of the aluminum forging opposite to the lower surface is brought into contact with the water. Therefore, the lower surface of the aluminum alloy forging is more rapidly cooled as compared with the upper surface, so that the lower surface has a higher strength than the upper surface. Therefore, it possible to provide an aluminum alloy forging for an automobile suspension capable of suppressing damage due to flying stones, etc., as an external factor.

Further, by using the forged product 20 obtained by the production method of the present invention, when the automobile actually travels on the road surface, damage is received from external factors (flying stones, etc.) from the road surface, but the surface with which the external factors come into contact is the lower surface quenched by contacting water first. Therefore, the lower surface has sufficient strength, so it is possible to minimize the damage.

The aluminum alloy forged product produced in this way has excellent tensile properties at room temperature. In addition, the surface susceptible to external factors is less sensitive to stress corrosion cracking. Therefore, for example, it is suitably used as a material for an automobile suspension component (suspension arm, upper arm, lower arm, tie rod end, etc.).

### EXAMPLES

Next, specific examples of the present invention will be described, but the present invention is not particularly limited to these examples.

### Example 1

By heating an aluminum alloy consisting of Si: 1.10 mass %, Fe: 0.25 mass %, Cu: 0.40 mass %, Mn: 0.50 mass %, Mg: 0.85 mass %, Cr: 0.15 mass %, and the balance being Al and inevitable impurities, an aluminum alloy molten metal was obtained. Thereafter, a continuously cast material was obtained by performing continuous casting with a casting diameter of 60 mm using the aluminum alloy molten metal. The continuous casting was performed at a cooling rate of 30° C./min at the time of the continuous casting. The obtained continuously cast material was subjected to a homogenizing heat treatment at 470° C. for 7 hours, and then air-cooled.

Next, after the continuously cast material after air cooling was cut to a length of 80 mm, the cut casting material 10 (see FIG. 4) was subjected to hot forging at a material temperature of 530° C., a die temperature of 180° C., and after water quenching in water at 50° C. immediately after the forging, it was subjected to an artificial age hardening process by heating for 6 hours at 180° C. to obtain a forged product 20.

The water quenching treatment process was performed by bringing the lower surface into contact with water prior to the upper surface. That is, the lower surface 21 to be subjected to water quenching first was arranged parallel and adjacent to the water surface W, and the forged product 20 was subjected to a free fall from 300 mm above the water surface W to perform water quenching. At this time, the upper surface 22 was located relatively above the water surface W via the lower surface 21, and as a result, it comes into contact with water after the lower surface 21 to be water-quenched.

### Example 2

By heating an aluminum alloy consisting of Si: 1.10 mass %, Fe: 0.25 mass %, Cu: 0.40 mass %, Mn: 0.50 mass %, Mg: 0.85 mass %, Cr: 0.15 mass %, and the balance being Al and inevitable impurities, an aluminum alloy molten metal was obtained. Thereafter, a continuously cast material was obtained by performing continuous casting with a casting diameter of 60 mm using the aluminum alloy molten metal. The continuous casting was performed at a cooling rate of 30° C./min at the time of the continuous casting. The obtained continuously cast material was subjected to a homogenizing heat treatment at 470° C. for 7 hours, and then air-cooled.

Next, after the continuously cast material after air cooling was cut to a length of 80 mm, the cut casting material 10 (see FIG. 4) was subjected to hot forging at a material temperature of 530° C. and die temperature of 180° C., a forged product 20 having a shape as shown in FIG. 5 was obtained.

Next, the obtained forging 20 was heated at 540° C. for 3 hours to carry out a solution heat treatment, then put in water at 50° C. to carry out water quenching, and then heated at 180° C. for 6 hours to perform an artificial age hardening process to obtain the forged product 20.

The water quenching treatment process was performed by bringing the lower surface into contact with water prior to the upper surface. That is, the lower surface 21 to be subjected to water quenching first was arranged parallel and adjacent to the water surface W, and the forged product 20 was subjected to a free fall from 300 mm above the water surface W to perform the water quenching. At this time, the upper surface 22 is located relatively above the water surface W via the lower surface 21, and as a result, it comes into contact with water after the lower surface 21 and water-quenched.

### Example 3

After heating an aluminum alloy consisting of Si: 1.10 mass %, Fe: 0.25 mass %, Cu: 0.40 mass %, Mn: 0.50 mass %, Mg: 0.85 mass %, Cr: 0.15 mass %, and the balance being Al and inevitable impurities to obtain an aluminum alloy molten metal, a continuously cast material was obtained by performing continuous casting with a casting diameter of 60 mm using the aluminum alloy molten metal. The continuous casting was performed at a cooling rate of 30° C./min at the time of the continuous casting. The obtained continuously cast material was subjected to a homogenizing heat treatment at 470° C. for 7 hours, and then air-cooled.

Next, after the continuously cast material after air cooling was cut to a length of 80 mm, the cut casting material 10 (see FIG. 4) was subjected to hot forging at a material temperature of 530° C., a die temperature of 180° C., and after warm water quenching was performed in warm water of a temperature of 80° C. immediately after the forging, it was subjected to an artificial age hardening process by heating for 6 hours at 180° C. and a forged product 20 was obtained.

The water quenching treatment process was performed by bringing the lower surface into contact with water prior to the upper surface. That is, the lower surface 21 to be subjected to water quenching first was arranged parallel and adjacent to the water surface W, and the forged product 20 was subjected to a free fall from 300 mm above the water surface W to perform the water quenching. At this time, the upper surface 22 is located relatively above the water surface W via the lower surface 21, and as a result, it comes into contact with water after the lower surface 21 and water-quenched.

### Example 4

After heating an aluminum alloy consisting of Si: 1.10 mass %, Fe: 0.25 mass %, Cu: 0.40 mass %, Mn: 0.50 mass %, Mg: 0.85 mass %, Cr: 0.15 mass %, and the balance being Al and inevitable impurities to obtain an aluminum alloy molten metal, a continuously cast material was obtained by performing continuous casting with a casting diameter of 60 mm using the aluminum alloy molten metal. The continuous casting was performed at a cooling speed of 30° C./min at the time of the continuous casting. The obtained continuously cast material was subjected to a homogenizing heat treatment at 47° C. for 7 hours, and then air-cooled.

Next, after the continuously casting material after air cooling was cut to a length of 80 mm, the cut casting material 10 (see FIG. 4) was subjected to hot forging at a material temperature of 530° C., a die temperature of 180° C., and a forged product 20 having a shape as shown in FIG. 5 was obtained.

Next, the obtained forging 20 was heated at 540° C. for 3 hours to perform the solution heat treatment, then placed in warm water at 80° C. to perform warm water quenching, and then heated at 180° C. for 6 hours to perform the artificial age hardening process to obtain the forged product 20.

The water quenching treatment process was performed by bringing the lower surface into contact with water prior to the upper surface. That is, the lower surface 21 to be subjected to water quenching first was arranged parallel and adjacent to the water surface W, and the forged product 20 was subjected to a free fall from 300 mm above the water surface W to perform the water quenching. At this time, the upper surface 22 is located relatively above the water surface W via the lower surface 21, and as a result, it comes into contact with water after the lower surface 21 and water-quenched.

TABLE 1

| | Hardness of the | Hardness of the |
|---|---|---|
| | surface brought into | surface brought into |
| | contact with water | contact with water |
| | first and quenched | later and quenched |
| Example 1 | 74.2 | 71.8 |
| Example 2 | 74.6 | 72.2 |
| Example 3 | 73.7 | 71.1 |
| Example 4 | 74.3 | 71.9 |

The forged products 20 of Examples 1 to 4 obtained as described above were evaluated variously in accordance with the following evaluation methods.

### <Hardness Measurement>

In the obtained forged product 20, the hardness of the lower surface 21 which was subjected to quenching by being brought into contact with water first and the hardness of the upper surface 22 on the opposite side of the lower surface 21 were measured. Specifically, the forged product 20 was cut into 10 mm square, resin-filled, and the target surface was polished to #2000 with an emery paper, and the Vickers hardness was measured using a Vickers hardness meter. The load at the time of the Vickers hardness measurement was 10 g, and the measurement was performed at 10 points per sample to calculate the average Vickers hardness. The measurement results of the Vickers hardness are shown in Table 1.

From Table 1, in each example, it can be seen that the lower surface 21 which was brought into contact with water prior and quenched has a higher Vickers hardness than the upper surface 22 which was brought into contact with water and quenched later.

Therefore, the lower surface which was brought into contact with water and quenched first has sufficient strength as compared with the upper surface which was brought into contact with water and quenched later, and it is possible to suppress the occurrence of a starting point of fatigue fracture.

### INDUSTRIAL APPLICABILITY

In the aluminum alloy forged product for automobile suspension obtained by the production method of the present invention, the surface susceptible to disturbance is sufficiently high in strength, and therefore, for example, it is suitably used as a material for a suspension arm for automobile, upper arm, lower arm, a tie rod end, or the like, but not particularly limited to such applications.

This application claims priority to Japanese Patent Application No. 2019-213983, filed on Nov. 27, 2019, the disclosure of which is incorporated herein by reference in its entirety.

The terms and expressions used herein are for illustration purposes only and are not used for limited interpretation, do not exclude any equivalents of the features shown and stated herein, and it should be recognized that the present invention allows various modifications within the scope of the present invention as claimed.

### DESCRIPTION OF SYMBOLS

10: Casting (cast material)

20: Forging (forged material)

21: Bottom surface

22: Upper surface

1. A production method of an aluminum alloy forging for an automobile suspension, the method comprising, as heat treatment processes:
a solution heat treatment process;
a quenching process; and
an artificial age hardening process,
wherein the quenching process is performed by bringing a lower surface of the aluminum forging to be disposed on a ground side when assembled to an automobile into contact with water before an upper surface of the aluminum forging opposite to the lower surface is brought into contact with the water.

2. The production method of an aluminum alloy forging for an automobile suspension as recited in claim 1,
wherein an aluminum alloy constituting the aluminum alloy forging is an Al—Mg—Si based alloy.

3. The production method of aluminum alloy forging for an automobile suspension as recited in claim 1, further comprising:
a hot forging process performed immediately before the solution heat treatment process,
wherein the solution heat treatment process is performed in conjunction with a temperature rise in the hot forging process.

4. The production method of an aluminum alloy forging for an automobile suspension as recited in claim 2, further comprising:
a hot forging process performed immediately before the solution heat treatment process,
wherein the solution heat treatment process is performed in conjunction with a temperature rise in the hot forging process.

5. The production method of an aluminum alloy forging for an automobile suspension as recited in claim 1,
wherein a temperature of the water in the quenching process is 40° C. to 90° C.

6. The production method of an aluminum alloy forging for an automobile suspension as recited in claim 2,
wherein a temperature of the water in the quenching process is 40° C. to 90° C.

7. The production method of an aluminum alloy forging for an automobile suspension as recited in claim 3,
wherein a temperature of the water in the quenching process is 40° C. to 90° C.

8. The production method of an aluminum alloy forging for an automobile suspension as recited in claim 4,
wherein a temperature of the water in the quenching process is 40° C. to 90° C.
